(19) United States
(12) Patent Application Publication
(10) Pub. No.: US 2013/0244547 A1
(43) Pub. Date: Sep. 19, 2013

(54) Wood Sanding Bit and Method of Use

(71) Applicant: Urbain Morelli, Saskatoon (CA)

(72) Inventor: Urbain Morelli, Saskatoon (CA)

(21) Appl. No.: 13/617,859

(22) Filed: Sep. 14, 2012

(30) Foreign Application Priority Data
Sep. 15, 2011 (CA) 2752380

(51) Int. Cl. B27G 13/12; B27M 1/08; B27G 13/00; B24D 5/00

(52) U.S. Cl. CPC B27G 13/12; B24D 5/00; B27M 1/08; B27G 13/002
USPC 451/54; 451/547; 451/28; 144/241

(57) ABSTRACT

The invention seeks to provide a wood sanding bit that can be used for the sanding of routered work piece edges. Specifically, the invention seeks to provide a wood sanding bit for use with a rotary tool, the bit comprising a sanding body having an outwardly and radially disposed sanding surface, the sanding surface provided with an abrasive material, wherein the sanding surface has a profile corresponding to a standard contoured router bit profile.

### FIELD OF THE INVENTION

The invention relates to woodworking tools and accessories, and specifically to tools and accessories for sanding wooden work pieces.

### BACKGROUND OF THE INVENTION

It is well known in the field of woodworking to sand a work piece after rough shaping has been completed. This sanding may be done before final finishing steps are undertaken, or the sanding itself may be the final finishing step depending on the type of end product that is sought.

It is also well known in the field of woodworking to employ a router to cut a profiled edge into a wooden work piece. Various router bits have been developed over the years and have come into common usage, such as the Roman ogee and the roundover, and such router bits have been given standard sizes and shapes that now enjoy wide usage throughout the field.

In some cases a routered edge is considered to be adequate as a final finish, but in other cases it is desirable to sand that routered profile. However, given the complexity of many routered profiles, it is very difficult to engage in the fine sanding required. Also, sanding of routered profiles may be desirable where paint or some other type of finishing coat has previously been applied to a routered profile; again, the ability to sand in such a setting is extremely difficult.

While hand sanding has been used in the past for such purposes, using sanding sponges and files for example, this is time-consuming and sometimes results in a product that is not as neatly finished as desired. Alternatives such as stripping chemical compounds are sometimes employed where it is desired to strip a paint or other coated finish, but this is also time-consuming and requires the use of harsh and sometimes toxic chemicals.

Sanding or grinding bits are known in the field, such as bands, discs and abrasive brushes, which are manufactured by companies such as Dremel, a division of Robert Bosch Tool Corporation. However, most sanding bits are cylindrical or conical, and accordingly are of little if any use in the sanding of routered profiles. Canadian Patent Application No. 2,471,927 discloses a sanding bit that comprises a slot in a distal end of the bit for receiving a piece of standard sandpaper, but this provides a sanding bit similar in shape and utility to a sanding drum, and again this is of little if any use in the sanding of routered profiles. Woodworkers accordingly continue to rely on hand sanding and stripping chemicals when they need to sand a work piece having a routered profile.

What is needed, therefore, is a sanding tool that can be employed in the sanding of profiled work pieces, to reduce time consumption and the use of stripping chemicals.

### SUMMARY OF THE INVENTION

The present invention therefore seeks to provide a woodworking accessory that can be used with common rotary tools such as routers to sand/strip routered profiles.

According to a first aspect of the present invention there is provided a wood sanding bit for use with a rotary tool, the bit comprising:

a sanding body having an axis of rotation and an outwardly and radially disposed sanding surface, the sanding surface provided with an abrasive material; and

a rotatable shank connected coaxially to the sanding body for connection to the rotary tool;

wherein the sanding surface has a profile corresponding to a standard contoured router bit profile.

According to a second aspect of the present invention there is provided a method for sanding a routered profile of a wooden work piece, the method comprising the steps of:
a. providing a wood sanding bit comprising a sanding body having an axis of rotation and an outwardly and radially disposed sanding surface, the sanding surface provided with an abrasive material, and a rotatable shank connected coaxially to the sanding body, wherein the sanding surface has a profile corresponding to the routered profile;
b. inserting the shank into a rotary tool and securing the shank therein;
c. causing the wood sanding bit to rotate by means of the rotary tool;
d. applying the rotating wood sanding bit to the routered profile; and
e. allowing the sanding surface to contact and sand the routered profile.

According to a third aspect of the present invention there is provided a method for forming a finished contoured profile in a wooden work piece, the method comprising the steps of:
a. providing a router bit and a rotary tool;
b. inserting the router bit into the rotary tool and securing it therein;
c. causing the router bit to rotate by means of the rotary tool;
d. applying the router bit to the wooden work piece to form a rough contoured profile in the wooden work piece;
e. providing a wood sanding bit comprising a sanding body having an axis of rotation and an outwardly and radially disposed sanding surface, the sanding surface provided with an abrasive material, and a rotatable shank connected coaxially to the sanding body, wherein the sanding surface has a profile corresponding to the profile of the router bit;
f. replacing the router bit with the wood sanding bit;
g. causing the wood sanding bit to rotate by means of the rotary tool;
h. applying the rotating wood sanding bit to the rough contoured profile; and
i. allowing the sanding surface to contact and sand the rough contoured profile to form a finished contoured profile.

According to a fourth aspect of the present invention there is provided a kit of parts for use in applying a contoured profile to a wooden work piece, the kit of parts comprising:

a router bit; and

a sanding bit, the sanding bit comprising a sanding body having an axis of rotation and an outwardly and radially disposed sanding surface, the sanding surface provided with an abrasive material, and a rotatable shank connected coaxially to the sanding body;

wherein the sanding surface has a profile corresponding to the profile of the router bit.

In exemplary embodiments of the present invention, the sanding body and rotatable shank are composed of steel, and the rotatable shank has a diameter selected from the group consisting of ⅛ inch, ¼ inch, and ½ inch. The standard contoured router bit profile is preferably selected from the group consisting of: plunge, rabbet, dado, slot, flush trim, mortise, roundover, plunge roundover, edge bead, cove, core box, bowl and tray, bullnose, ball end, chamfer, v-groove, bevel, dovetail, Roman ogee, fillet cove, corner bead, multi-bead, multi-flute, table edge, slide and rail, sash, raised panel, finger pull, tongue and groove, lock mitre, drawer lock, glue joint, finger joint, and moulding. Further, in exemplary embodiments of the present invention, the sanding surface extends over substantially the entire sanding body, and the abrasive material has a grit size range of 60 grit to 600 grit.

A detailed description of an exemplary embodiment of the present invention is given in the following. It is to be understood, however, that the invention is not to be construed as being limited to this embodiment.

### BRIEF DESCRIPTION OF THE DRAWINGS

In the accompanying drawings, which illustrate an exemplary embodiment of the present invention:

FIG. 1 is an elevation view and a top plan view of a sanding bit in accordance with the present invention;

FIGS. 2a and 2b are elevation views of two standard router bits and the corresponding profiles they cut in wooden work pieces;

FIG. 3 is a kit comprising a router bit and a corresponding sanding bit; and

FIG. 4 is an elevation view of a sanding bit in a rotary tool.

A preferred embodiment of the present invention will now be described with reference to the accompanying drawings.

### DETAILED DESCRIPTION OF EXEMPLARY EMBODIMENTS

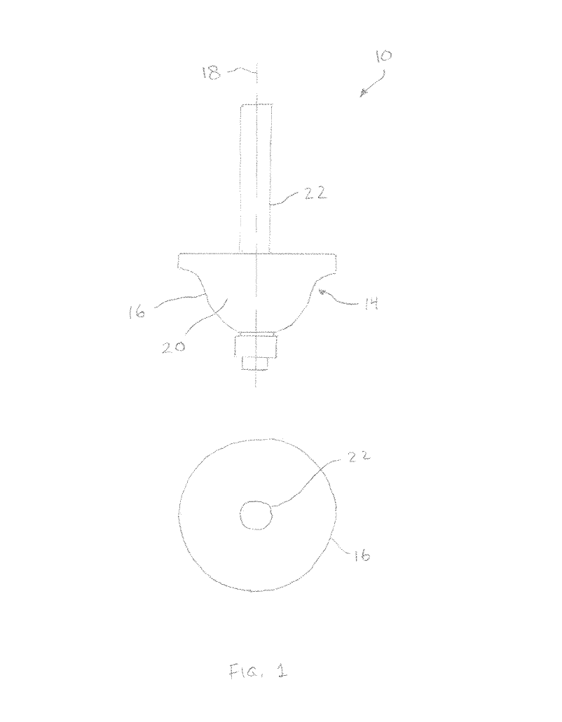

Referring now in detail to the accompanying drawings, an embodiment of the present invention is illustrated. Referring to FIG. 1, a wood sanding bit 10 is illustrated, comprising a solid sanding body 14 and a rotatable shank 22. The sanding body 14 and rotatable shank 22 are preferably composed of steel and may be of unitary construction, although other materials may be used and the shank 22 and sanding body 14 may be initially constructed separately and only connected later during production of the bit 10, as would be obvious to one skilled in the art. The sanding body 14 is provided with a sanding surface 16 which comprises an abrasive material 20 disposed outwardly, and in preferred embodiments this sanding surface 16 extends over substantially the entire surface of the sanding body 14. The abrasive material 20 may comprise any grit known in the art to have particular utility in sanding of routered profiles, but it is preferred to have a grit size range of 60 grit to 600 grit, and most preferably in a variety of grit sizes to enable progressively smoother sanding finishes. The sanding body 14 has an axis of rotation 18 such that the sanding surface 16 is radially symmetrical about the axis of rotation 18, as can be seen most particularly in the top plan view. The shank 22 preferably has a diameter of ⅛ inch, ¼ inch or ½ inch to accommodate most standard router and rotary device collets. The sanding bit 10 could be manufactured in various ways that would be known to one skilled in the art; for example, it could be manufactured using a mould pour of an epoxy-based resin with a sand mixture for the desired abrasive material 20, or it could be machined in metal and an abrasive material 20 applied to the surface, or it could even be machined from grinding stone material using a laser cutter, all of which processes are known in the art and therefore need not be described further herein.

As can be seen in FIG. 1, the sanding body 14 of the bit 10 has a particular profile, and in the illustrated case that profile is known in the art as an “ogee” or “Roman ogee” profile. This is one of the many common, standard profiles for which router bits have been developed. Other common, standard profiles include the following: plunge, rabbet, dado, slot, flush trim, mortise, roundover, plunge roundover, edge bead, cove, core box, bowl and tray, bullnose, ball end, chamfer, v-groove, bevel, dovetail, fillet cove, corner bead, multi-bead, multi-flute, table edge, slide and rail, sash, raised panel, finger pull, tongue and groove, lock mitre, drawer lock, glue joint, finger joint, and moulding. Numerous other router bit profiles have also been developed, often but not necessarily for speciality applications. Sanding bits in accordance with the present invention are provided with a sanding surface that has a profile corresponding to a specific router bit profile. While most commonly the sanding bits would be provided with a sanding surface corresponding to one of the above standard contoured router bit profiles, it is fully within the scope of the present invention to include sanding bits with profiles corresponding to other, less common router bit profiles, and the invention is therefore not to be construed as being limited to sanding bits having profiles corresponding only to the listed router bit profiles. Note that the term “router bit” is intended to include both router bits and shaper bits and other wood-forming bit types known in the field of woodworking. A router bit is normally provided with one or more cutting edges, and typically two cutting edges, such that its outer surface is not symmetrical about its axis of rotation around the entire tool, unlike the sanding bit 10 of the present invention which is symmetrical about the axis of rotation 18 around the entire sanding bit 10, as can be seen in the top plan view of FIG. 1.

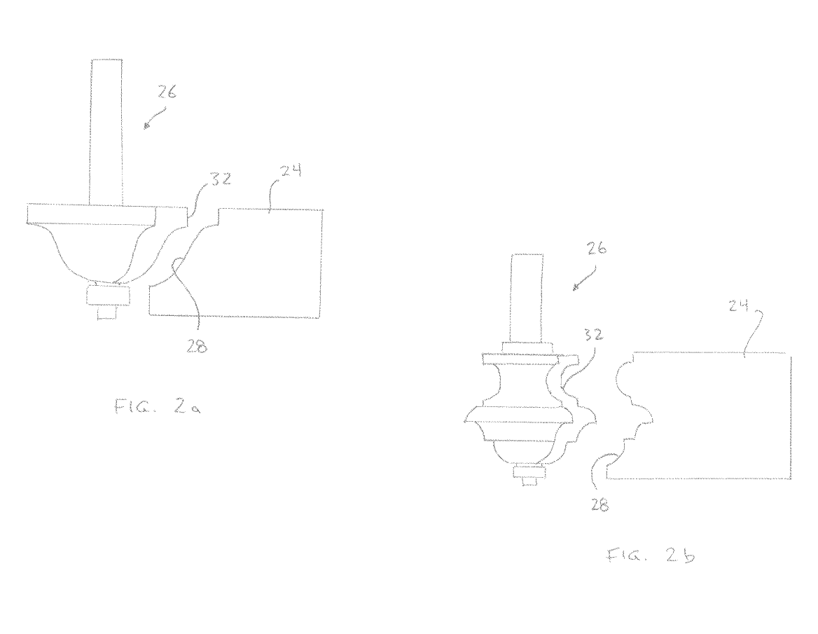

Referring now to FIGS. 2a, 2b and 4, a method according to the present invention for forming a finished contoured profile 28 in a wooden work piece 24 is illustrated. To produce a rough contoured profile 28 in a work piece 24, a router bit 26 is employed, the router bit 26 having a cutting edge 32 corresponding to the desired profile 28. In FIG. 2a, the profile 28 is an ogee profile, while in FIG. 2b the profile 28 is a moulding profile. A user would select a router bit 26 based on the desired profile 28, and insert and secure that router bit 26 in the chuck or collet 34 of a rotary tool 12 such as a router. The rotary tool 12 is then activated, causing rotation of the router bit 26. When applied to the edge of the work piece 24, the router bit 26 cuts into the work piece 24 by means of the cutting edge 32, thereby creating a rough cut along the work piece 24 that has the desired profile 28. Once the cut is completed, the router bit 26 can be removed and replaced with a sanding bit 10 in accordance with the present invention, having a profile substantially identical to that of the router bit 26. The rotary tool 12 is once again activated, causing rotation of the sanding bit 10. The sanding bit 10 can then be brought into contact with the routered profile 28 of the work piece 24, the abrasive material 20 of the sanding surface 16 sanding the profile 28 and thereby forming a smoother, finished profile 28.

The present invention also includes a method for sanding a routered profile, where the work piece 24 has been previously routered or a coating such as paint has been applied and it is desired to remove that coating. Referring again to FIG. 4, the method of sanding comprises providing a sanding bit 10 in accordance with the present invention and as illustrated in detail in FIG. 1. The shank 22 of the sanding bit 10 is inserted and secured in the chuck 34, and the rotary tool 12 is activated, causing rotation of the sanding bit 10. The sanding bit 10 can then be brought into contact with the routered profile 28 of the work piece 24, the abrasive material 20 of the sanding surface 16 sanding the profile 28. This can either sand a routered profile or strip a coating therefrom.

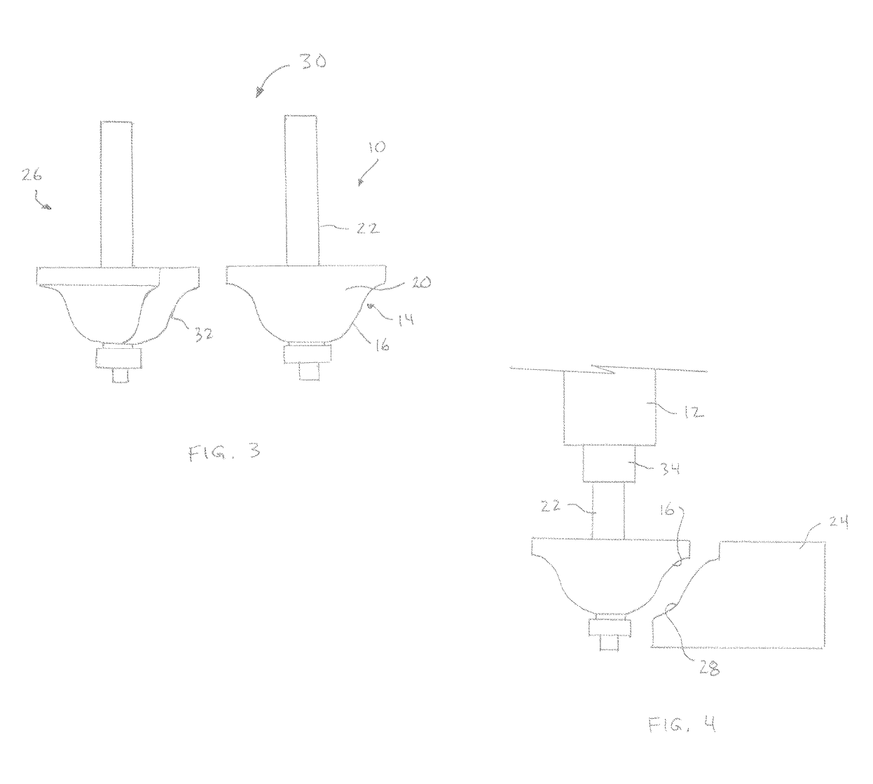

Finally, the present invention includes a kit of parts 30, as is illustrated in FIG. 3. Although sanding bits 10 in accordance with the present invention are intended to be manufactured to correspond to common, standard router bit profiles, it may be desirable to provide a sanding bit 10 with its corresponding router bit 26. This may be desirable for the sake of convenience—having both bits pre-packaged together—or in the case where a non-standard bit may be sought after, non-standard either in shape or size. FIG. 3 illustrates a paired router bit 26 and sanding bit 10, which would be provided together in a kit of parts having the desired utility.

The foregoing is considered as illustrative only of the principles of the invention. Thus, while certain aspects and embodiments of the invention have been described, these have been presented by way of example only and are not intended to limit the scope of the invention. Indeed, the invention described herein may be embodied in a variety of other forms without departing from the spirit of the invention, which invention is defined solely by the claims below.

1. A wood sanding bit for use with a rotary tool, the bit comprising:
a sanding body having an axis of rotation and an outwardly and radially disposed sanding surface, the sanding surface provided with an abrasive material; and
a rotatable shank connected coaxially to the sanding body for connection to the rotary tool;
wherein the sanding surface has a profile corresponding to a standard contoured router bit profile.

2. The wood sanding bit of claim 1 wherein the standard contoured router bit profile is selected from the group consisting of: plunge, rabbet, dado, slot, flush trim, mortise, roundover, plunge roundover, edge bead, cove, core box, bowl and tray, bullnose, ball end, chamfer, v-groove, bevel, dovetail, Roman ogee, fillet cove, corner bead, multi-bead, multi-flute, table edge, slide and rail, sash, raised panel, finger pull, tongue and groove, lock mitre, drawer lock, glue joint, finger joint, and moulding.

3. The wood sanding bit of claim 1 wherein the sanding surface extends over substantially the entire sanding body.

4. The wood sanding bit of claim 1 wherein the rotatable shank has a diameter selected from the group consisting of ⅛ inch, ¼ inch, and ½ inch.

5. The wood sanding bit of claim 1 wherein the sanding body and rotatable shank are composed of steel.

6. The wood sanding bit of claim 1 wherein the abrasive material has a grit size range of 60 grit to 600 grit.

7. A method for sanding a routered profile of a wooden work piece, the method comprising the steps of:
a. providing a wood sanding bit comprising a sanding body having an axis of rotation and an outwardly and radially disposed sanding surface, the sanding surface provided with an abrasive material, and a rotatable shank connected coaxially to the sanding body; wherein the sanding surface has a profile corresponding to the routered profile;
b. inserting the shank into a rotary tool and securing the shank therein;
c. causing the wood sanding bit to rotate by means of the rotary tool;
d. applying the rotating wood sanding bit to the routered profile; and
e. allowing the sanding surface to contact and sand the routered profile.

8. A method for forming a finished contoured profile in a wooden work piece, the method comprising the steps of:
a. providing a router bit and a rotary tool;
b. inserting the router bit into the rotary tool and securing it therein;
c. causing the router bit to rotate by means of the rotary tool;
d. applying the router bit to the wooden work piece to form a rough contoured profile in the wooden work piece;
e. providing a wood sanding bit comprising a sanding body having an axis of rotation and an outwardly and radially disposed sanding surface, the sanding surface provided with an abrasive material, and a rotatable shank connected coaxially to the sanding body; wherein the sanding surface has a profile corresponding to the profile of the router bit;
f. replacing the router bit with the wood sanding bit;
g. causing the wood sanding bit to rotate by means of the rotary tool;
h. applying the rotating wood sanding bit to the rough contoured profile; and
i. allowing the sanding surface to contact and sand the rough contoured profile to form a finished contoured profile.

9. A kit of parts for use in applying a contoured profile to a wooden work piece, the kit of parts comprising:
a router bit; and
a sanding bit, the sanding bit comprising a sanding body having an axis of rotation and an outwardly and radially disposed sanding surface, the sanding surface provided with an abrasive material, and a rotatable shank connected coaxially to the sanding body;
wherein the sanding surface has a profile corresponding to the profile of the router bit.
